(19) United States
(12) Patent Application Publication
(10) Pub. No.: US 2020/0117732 A1
(43) Pub. Date: Apr. 16, 2020

(54) ANALYSIS AND DETERMINATION OF RELATIVE CONSISTENCY OF IDENTIFIED RELATIONSHIPS

(71) Applicant: International Business Machines Corporation, Armonk, NY (US)

(72) Inventors: William Scott SPANGLER, San Martin, CA (US); Peter Jay HAAS, San Jose, CA (US); Alix LACOSTE, Brooklyn, NY (US); Meenakshi NAGARAJAN, San Jose, CA (US); Sheng Hua BAO, San Jose, CA (US); Feng WANG, Santa Clara, CA (US)

(21) Appl. No.: 16/157,245

(22) Filed: Oct. 11, 2018

(51) Int. Cl. G06F 17/30; G06F 17/27

(52) U.S. Cl. CPC G06F 17/30371; G06F 17/2705; G06F 17/30315; G06F 17/3053

(57) ABSTRACT

Techniques for analysis of relationship consistency are provided. A plurality of relationships is extracted from a plurality of documents, and a binary matrix is generated based on the plurality of relationships. A first relationship, of the plurality of relationships, is identified to be verified. A score of the first relationship in the binary matrix is set to a predefined value. Further, a factorization is performed on the binary matrix to produce a first matrix and a second matrix. A first consistency score is calculated for the first relationship by multiplying at least a portion of the first matrix and a second matrix. The first consistency score is ranked as compared to at least one other consistency score associated with at least one other relationship of the plurality of relationships. Finally, an indication of the first relationship is provided, based on the ranking.

### BACKGROUND

The present disclosure relates to analysis of concepts and relationships, and more specifically, to automatically determining the relative consistency of identified relationships, based on scientific literature.

In a wide variety of fields, significant time and resources are dedicated to conducting research and experiments to identify and understand concepts, as well as the relationships between concepts. Frequently, it is difficult to determine the accuracy or consistency of a given finding (e.g., a relationship). This is particularly true for individuals who are not subject-matter experts in the field. In many fields, a peer-review process is utilized to confirm each newly identified relationship. Over time, as additional research is completed, findings can be accepted or rejected by the community. However, in many instances, this peer-review process is never completed. Additionally, when others do attempt to confirm the accuracy of the discovery, the review is a slow and expensive process.

### SUMMARY

According to one embodiment of the present disclosure, a method is provided. The method includes extracting a plurality of relationships from a plurality of documents by operation of one or more computer processors, and generating a binary matrix based on the plurality of relationships. The method further includes identifying a first relationship, of the plurality of relationships, to be verified, and setting a score of the first relationship in the binary matrix to a predefined value. Additionally, the method includes performing a factorization on the binary matrix to produce a first matrix and a second matrix. The method also includes calculating a first consistency score for the first relationship by multiplying at least a portion of the first matrix and a second matrix. The method further includes ranking the first consistency score as compared to at least one other consistency score associated with at least one other relationship of the plurality of relationships Finally, the method includes providing an indication of the first relationship, based on the ranking.

According to a second embodiment of the present disclosure, a computer program product is provided. The computer program product includes a computer-readable storage medium having computer-readable program code embodied therewith, the computer-readable program code executable by one or more computer processors to perform an operation. The operation includes extracting a plurality of relationships from a plurality of documents, and generating a binary matrix based on the plurality of relationships. The operation further includes identifying a first relationship, of the plurality of relationships, to be verified, and setting a score of the first relationship in the binary matrix to a predefined value. Additionally, the operation includes performing a factorization on the binary matrix to produce a first matrix and a second matrix. The operation also includes calculating a first consistency score for the first relationship by multiplying at least a portion of the first matrix and a second matrix. The operation further includes ranking the first consistency score as compared to at least one other consistency score associated with at least one other relationship of the plurality of relationships Finally, the operation includes providing an indication of the first relationship, based on the ranking.

According to a third embodiment of the present disclosure, a system is provided. The system includes one or more computer processors, and a memory containing a program which when executed by the one or more computer processors performs an operation. The operation includes extracting a plurality of relationships from a plurality of documents, and generating a binary matrix based on the plurality of relationships. The operation further includes identifying a first relationship, of the plurality of relationships, to be verified, and setting a score of the first relationship in the binary matrix to a predefined value. Additionally, the operation includes performing a factorization on the binary matrix to produce a first matrix and a second matrix. The operation also includes calculating a first consistency score for the first relationship by multiplying at least a portion of the first matrix and a second matrix. The operation further includes ranking the first consistency score as compared to at least one other consistency score associated with at least one other relationship of the plurality of relationships Finally, the operation includes providing an indication of the first relationship, based on the ranking.

### BRIEF DESCRIPTION OF THE SEVERAL VIEWS OF THE DRAWINGS

FIG. 1 illustrates a system for analyzing the relative consistency of identified relationships between concepts, according to one embodiment disclosed herein.

FIG. 2 is a block diagram of a document analysis device configured to analyze publications and literature, identify related concepts, and determine the relative consistency of each relationship, according to one embodiment disclosed herein.

FIG. 3 illustrates a workflow for generation of a knowledge graph and matrix for determining relative consistency of relationships, according to one embodiment disclosed herein.

FIG. 4 is a flow diagram illustrating a method of generating a knowledge graph to determine the relative consistency of identified relationships, according to one embodiment disclosed herein.

FIG. 5 is a flow diagram illustrating a method of generating a matrix to be used in analyzing relationships between concepts in order to determine the relative consistency of each relation, according to one embodiment disclosed herein.

FIG. 6 is a flow diagram illustrating a method of determining the relative consistency of relationships, according to one embodiment disclosed herein.

FIG. 7 is a flow diagram illustrating a method for scoring the relative consistency of a relationship based on relevant or related relationships, according to one embodiment disclosed herein.

FIG. 8 is a flow diagram illustrating a method of analyzing the relative consistency of relationships between concepts, according to one embodiment disclosed herein.

### DETAILED DESCRIPTION

Embodiments of the present disclosure provide techniques to cognitively and automatically determine the consistency of an identified relationship, relative to other relationships and concepts in the field. Although the absolute truth of a finding may be difficult (or impossible) to determine, determining whether the finding is consistent with other known findings can serve as a useful indicator as to the truth of the finding. For example, if a new relationship is not consistent with other known findings, it is likely to be either erroneous (e.g., untrue or inaccurate), or extremely novel (such that existing literature has not considered or anticipated the finding). In either case, the result should not be trusted at face value, and further investigation must be undertaken. However, as our understanding of any given field advances, there is an ever-increasing volume of publications and literature, as well as an increasing velocity and frequency with which literature is published. This makes it impossible to determine the consistency of any given a finding using existing solutions.

Further, for many computer or data models to operate adequately (such as machine learning models), a large amount of training data is typically required. Ensuring the accuracy of this training data is often important, or the quality of the final model suffers significantly. Owing to the large amount of training data required, however, it is frequently impossible or resource-prohibitive to manually confirm or validate each piece of data. As such, techniques are often utilized to autonomously extract knowledge from documents (such as concepts and relationships between the concepts) for use as training data. These techniques can sometimes misidentify concepts or relationships, however, leading to unclean or inaccurate data. Embodiments of the present disclosure can be utilized to check the relative consistency of each automatically identified relationship. If the consistency is below a predefined threshold, the relationship can be flagged for further investigation to determine whether the ingestion models failed to accurately function. Advantageously, the ingestion models (e.g., the natural language processing algorithms utilized) can then be refined to better identify relationships and concepts in the future. Additionally, the training process for the machine learning model is greatly streamlined, as the majority of training data is acquired automatically. At the same time, questionable or inaccurate data is automatically detected, using embodiments herein, in order to ensure the quality of the model remains high.

Thus, embodiments of the present disclosure can be utilized in a variety of applications. In some embodiments, some or all of the relationships are validated to confirm that they adequately represent the existing literature. Such an embodiment may be particularly useful to test the validity or accuracy of a published relationship in newer (for example, un-reviewed) documents. This implementation is therefore useful to test human knowledge, and the truth or accuracy of scientific findings. In other embodiments, some or all of the relationships are automatically harvested or ingested using various techniques and algorithms, and one or more of the identified relationships are processed using embodiments disclosed herein to check their relative consistency. If the consistency is below a threshold, embodiments disclosed herein can determine that the ingestion techniques may be flawed, and flag them for review and correction. This implementation is therefore useful to test the quality of the ingestion algorithms, and ensure adequate results in machine learning.

In one embodiment, determining whether a relationship's consistency score is below a threshold includes determining a proper threshold. In an embodiment, the threshold for the relationship is based in part on other similar or relevant relationships. For example, in one embodiment, consistency scores are generated for a number of related relationships, and the index relationship (e.g., the relationship being tested or verified) is ranked or compared to the other consistency scores. If the index relationship's consistency score falls below the threshold, as compared to the other scores, the index relationship may be suspicious or unverified.

Embodiments of the present disclosure involve parsing and analyzing literature to identify concepts and relationships discussed or disclosed. In an embodiment, these relationships are utilized to construct a knowledge graph and/or matrix representing the relationships. In one embodiment, a binary matrix is generated to represent the relationships, and the matrix is factorized to generate two other matrices. In an embodiment, part or all of these matrices can then be combined, as discussed in more detail below, to generate a consistency score for each relationship in the original matrix, relative to each other relationship. In some embodiments, other relationships related to the relationship being tested are identified, and the consistency scores for each related relationship are compared to the identified relationship in order to determine its relative consistency with respect to relevant findings.

Embodiments of the present disclosure can be utilized to determine the relative consistency of an identified relationship in any domain. For example, embodiments of the present disclosure can be applied to any scientific or medical field, such physics, chemistry, earth science, ecology, oceanography, geology, meteorology, space science and astronomy, biology, zoology, botany, decision theory, logic, mathematics, statistics, systems theory, computer science, engineering, medicine, and the like. In embodiments, literature or publications are parsed to identify relationships. As used herein, literature or publications refers to any document or data structure that includes concepts and/or relationships between concepts. For example, literature can include papers, articles, blog posts, essays, and the like (however formally they are published). In some embodiments, the literature also includes non-natural language sources such as databases. Similarly, in some embodiments, the literature can include non-written materials, such as video, audio, and the like.

In some embodiments, the relationships are defined in machine-readable format that allows quick and easy ingestion. For example, in some embodiments, a user or administrator confirms or validates the relationships, and embodiments disclosed herein are utilized to check the accuracy and consistency of each. In other embodiments, various techniques are utilized to ingest relationships (such as natural language processing, optical character recognition, image processing and recognition, speech recognition, and the like). These relationships are then similarly processed utilizing embodiments disclosed herein, in order to identify potential mistakes or inaccuracies in the ingestion process.

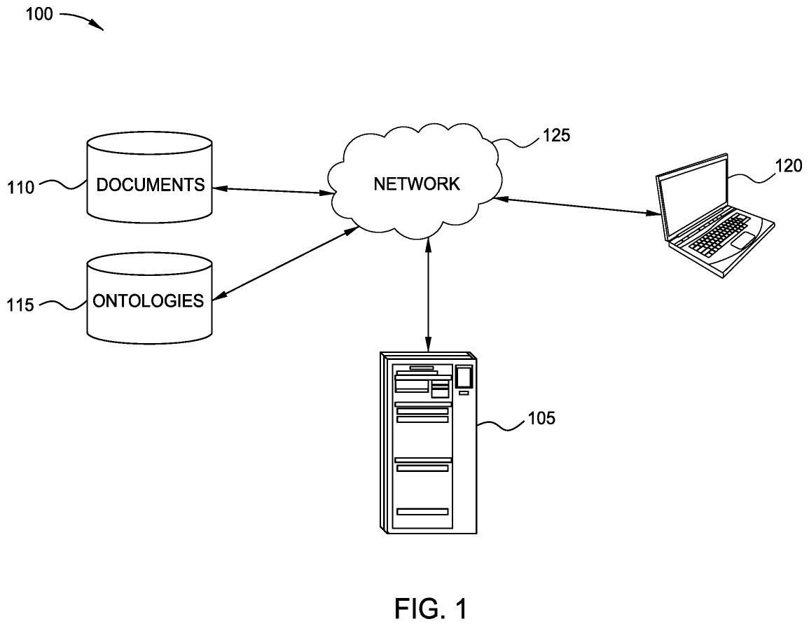

FIG. 1 illustrates a system 100 for analyzing the relative consistency of identified relationships between concepts, according to one embodiment disclosed herein. In the illustrated embodiment, a Document Analysis Device 105 is communicatively coupled with one or more data stores for Documents 110, as well as Ontologies 115 via a Network 125. As illustrated, the Document Analysis Device 105 is further coupled with a User Device 120. In an embodiment, users or administrators utilize the User Device 120 to interact with the Document Analysis Device 105, in order to analyze the Documents 110.

Although illustrated as residing in multiple remote data stores, in embodiments, the Documents 110 and Ontologies 115 may reside on a single device, on the Document Analysis Device 105, or distributed across any number of data stores or storage locations. In an embodiment, the Documents 110 include scientific literature relating to any number of fields and domains. In some embodiments, each field is associated with its own set of Documents 110. Generally, each piece of data in the Documents 110 includes concepts and relationships that have been identified in a field. For example, the Documents 110 may include papers or articles about experiments or studies investigating relationships between concepts.

In the illustrated embodiment, the Ontologies 115 include information about the vocabulary used in a specific domain to describe the various concepts. In one embodiment, the Ontologies 115 list the relevant concepts in the field. In some embodiments, the Ontologies 115 also indicate the types of relationships that are typically found in the domain. Further, in one embodiment, the Ontologies 115 can include an indication that two or more words or phrases are used interchangeably to refer to the same concept (e.g., a medicinal ontology may indicate that two names are used to refer to the same medication). In an embodiment, the Ontologies 115 include the relevant canonical forms or unique identifications for each concept in the domain (e.g., the base concept, such as a species, a gene, or a chemical), along with an indication of modifications and other names that refer to the same base concept. In some embodiments, each domain or field utilizes a separate Ontology 115. In one embodiment, the ontologies are defined by subject matter experts (SMEs) in the relevant domain. In some embodiments, one or more of the ontologies are identified based on parsing the relevant Documents 110.

In an embodiment, the Document Analysis Device 105 parses the Documents 110 to identify the concepts and relationships between concepts reflected in one or more of the Documents 110. In some embodiments, the Document Analysis Device 105 utilizes the Ontologies 115 during this process. For example, in one embodiment, the Document Analysis Device 105 uses one or more natural language processing (NLP) techniques to parse documents in the Documents 110 to search for concepts that are enumerated in one or more relevant Ontologies 115. In some embodiments, the Document Analysis Device 105 can also identify concepts that are not enumerated in the Ontologies 115, based on applying the NLP techniques.

In some embodiments, the Document Analysis Device 105 also determines if two or more concepts are, in fact, the same concept (based on the Ontologies 115). For example, if a paper refers to a medication by its brand name and by its generic name, the Ontology 115 may indicate that they are the same medication. Based on this Ontology 115, the Document Analysis Device 105 can determine that any relationship identified with respect to the first concept is also applicable to the second, and vice versa. In some embodiments, the Document Analysis Device 105 identifies relationships that are reflected in the documents. For example, in one embodiment, the Document Analysis Device 105 identifies a type of the relationship, as well as the agent and the target of the relationship.

For example, in an embodiment, a relationship type “acts on” may be identified based on determining that one or more documents in the Documents 110 mentions that agent A acts on a target B. Additionally, another relationship type is the “has property” relationship, where an agent A has the property of target B. In one embodiment, the agent and target are inferred based on the structure of the sentence. For example, in one embodiment, the “agent” is the concept which is the subject of the sentence, and the “target” is the concept which is the object of the sentence. Thus, in some embodiments, the relationships can be directional (e.g., A has property B, but B does not necessarily have property A). In some embodiments, one or more of the identified relationships may be bidirectional. In some embodiments, the Document Analysis Device 105 further determines the type of each relationship, based at least in part on the verb used to connect the agent and the target. In this way, a domain-specific Ontology 115 enables the Document Analysis Device 105 to identify, using one or more NLP techniques, concepts and relationships in each document in the Documents 110. In some embodiments, one or more of the relationships are verified or validated by a user (e.g., a subject matter expert) prior to use. In other embodiments, the identified relationships are used without manual validation (for example, in order to identify potential problems with the ingestion techniques).

In some embodiments, the Document Analysis Device 105 generates a knowledge graph reflecting these insights, as discussed below in more detail. Further, in embodiments, the Document Analysis Device 105 generates a binary matrix based on the relationships, or based on the knowledge graph, as discussed in more detail below. By manipulating the knowledge matrix, in an embodiment, the Document Analysis Device 105 can generate consistency scores for any given relationship, as discussed below in more detail. Further, in an embodiment, the Document Analysis Device 105 analyzes the knowledge graph and/or the knowledge matrix to identify related or relevant relationships to the index relationship, as discussed below in more detail. This enables rapid comparison between the index relationship (e.g., the relationship to be tested) and other relevant or similar relationships.

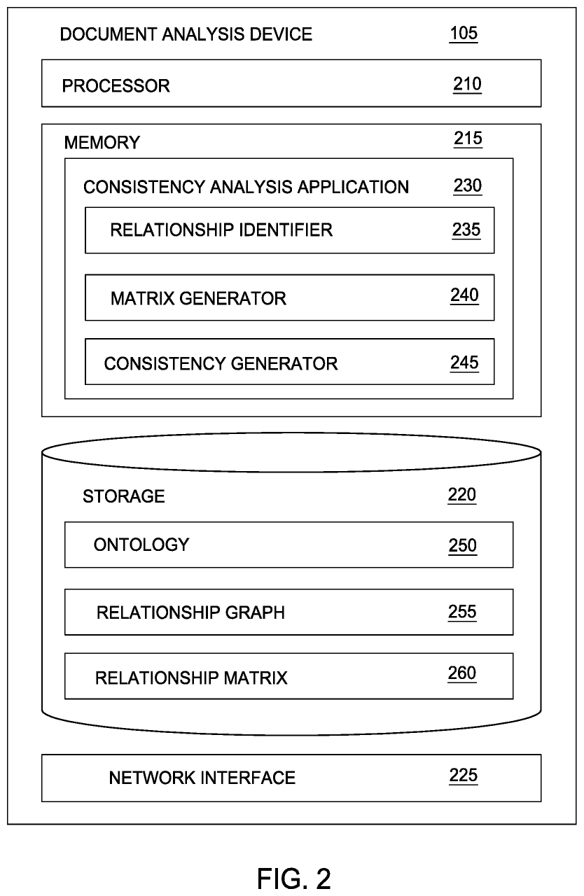

FIG. 2 is a block diagram of a Document Analysis Device 105 configured to analyze publications and literature, identify related concepts, and determine the relative consistency of each relationship, according to one embodiment disclosed herein. Although illustrated as a single device, in embodiments, the Document Analysis Device 105 may represent a system of devices, a combination of physical and virtual machines, and the like. As illustrated, the Document Analysis Device 105 includes a Processor 210, a Memory 215, Storage 220, and a Network Interface 225. In the illustrated embodiment, Processor 210 retrieves and executes programming instructions stored in Memory 215 as well as stores and retrieves application data residing in Storage 220. Processor 210 is representative of a single CPU, multiple CPUs, a single CPU having multiple processing cores, and the like. Memory 215 is generally included to be representative of a random access memory. Storage 220 may be a disk drive or flash-based storage device, and may include fixed and/or removable storage devices, such as fixed disk drives, removable memory cards, or optical storage, network attached storage (NAS), or storage area-network (SAN). Through the Network Interface 225, the Document Analysis Device 105 may be communicatively coupled with other devices, including data stores, user devices, and the like.

In the illustrated embodiment, the Storage 220 includes an Ontology 250, a Relationship Graph 255, and a Relationship Matrix 260. Although a single Ontology 250, Relationship Graph 255, and Relationship Matrix 260 are illustrated, in some embodiments, the Document Analysis Device 105 maintains multiple Ontologies 250, multiple Relationship Graphs 255, and multiple Relationship Matrices 260. For example, in one embodiment, each domain or field is associated with a respective Ontology 250, Relationship Graph 255, and Relationship Matrix 260. Additionally, although illustrated as residing in storage, in embodiments, the Ontologies 250, Relationship Graphs 255, and Relationship Matrices 260 may reside in one or more remote storage locations.

As illustrated, the Memory 215 includes a Consistency Analysis Application 230. In embodiments, the Consistency Analysis Application 230 parses literature/documents to identify relationships between concepts in a field or domain, and analyzes one or more of those relationships to determine a level of consistency, as compared to one or more other relationships found in the domain. To do so, in the illustrated embodiment, the Consistency Analysis Application 230 includes a Relationship Identifier 235, a Matrix Generator 240, and a Consistency Generator 245. Although illustrated as discrete components for ease of explanation, in embodiments, the operations of the Relationship Identifier 235, Matrix Generator 240, and Consistency Generator 245 may be combined or divided among one or more other components or devices. Further, in embodiments, the operations of the components can be implemented in software, hardware, or a combination of software and hardware.

In the illustrated embodiment, the Relationship Identifier 235 ingests documents (e.g., literature, publications, and the like) and identifies concepts and relationships between concepts. In some embodiments, the Relationship Identifier 235 utilizes a corresponding Ontology 250 to aid identification of concepts and relationships. In various embodiments, the Relationship Identifier 235 can utilize NLP techniques, speech recognition, image recognition, optical character recognition, and the like to ingest documents, depending on the type of the document (e.g., depending on whether it is purely text, includes images, multimedia, and the like).

Further, based on these identified relationships, the Relationship Identifier 235 generates a Relationship Graph 255 for the domain in one embodiment. In an embodiment, each node in the Relationship Graph 255 represents an identified concept, and each edge or connection represents an identified relationship between two or more concepts. In some embodiments, the links may be directional, where the direction of the link indicates which node (e.g., which concept) is the agent in the relationship, and which is the target. In some embodiments, the relationships and/or knowledge graph are validated or verified by one or more users or experts, in order to ensure they accurately represent the current literature.

In one embodiment, if a single instance of a particular relationship is identified (e.g., if at least one document mentions or specifies the relationship at least one time), the Relationship Identifier 235 generates a corresponding connection in the Relationship Graph 255. In some embodiments, the Relationship Identifier 235 adds a corresponding link only after the relationship has been found in the literature at least a predefined number of times (e.g., a minimum number of times, in one or more documents), in order to avoid populating the Relationship Graph 255 with questionable connections. In one embodiment, the relationship must be found in a predefined number of papers or documents before being added to the graph.

In some embodiments, the Relationship Identifier 235 receives and analyzes only documents that are sufficiently trustworthy. For example, in some embodiments, users or administrators can define certain publications, papers, conferences, and the like as being a trustworthy source. In some other embodiments, the Relationship Identifier 235 analyzes and parses a wide variety of documents, without regards to its source or trustworthiness. In some embodiments, the Relationship Identifier 235 also assigns a weight to each connection in the graph. For example, in embodiments, the weight can represent a confidence in the relationship. In an embodiment, the weight is based in part on the number of times the relationship was identified in the literature, how recently the relationship has been discussed or indicated in the literature, the trustworthiness of the document(s) the relationship was found in, and the like.

In the illustrated embodiment, the Matrix Generator 240 parses the Relationship Graph 255 to generate a Relationship Matrix 260. In an alternative embodiment, the Relationship Identifier 235 can generate the Relationship Matrix 260. In such an embodiment, the Relationship Identifier 235 may or may not first generate a Relationship Graph 255 (e.g., in some embodiments, the Relationship Matrix 260 is generated based directly on the identified relationships in the corpus, without creation of an interim Relationship Graph 255).

In the illustrated embodiment, the Matrix Generator 240 converts the Relationship Graph 255 into a binary matrix. In one embodiment, the Matrix Generator 240 creates a row in the Relationship Matrix 260 for each unique agent in the Relationship Graph 255 (e.g., for each node that has at least one link which begins at the node and terminates at another node). Further, in an embodiment, the Matrix Generator 240 creates a column in the Relationship Matrix 260 for each unique target in the Relationship Graph 255. Additionally, in an embodiment, the Matrix Generator 240 assigns the value for each element in the matrix (e.g., the intersection of a respective column and a respective row) based on whether the Relationship Graph 255 includes a connection between the agent associated with the respective row and the target associated with the respective column.

In some embodiments, the Relationship Matrix 260 is generated such that each row is a target concept and each column is an agent. Further, in some embodiments, there is no distinction as to the directionality of the relationships, and each concept identified is given both a row and a column.

In one embodiment, the Matrix Generator 240 assigns a value of “1” to the element if a corresponding relationship was found in the literature, and a value of “0” if no such relationship was identified. In this way, the Relationship Matrix 260 is a binary matrix. That is, the Relationship Matrix 260 includes binary values (one or zero). In some embodiments, the Matrix Generator 240 can assign higher values to indicate increased confidence in the relationship, or to reflect higher weight associated with the relationship, as discussed above. Further, as the majority of the concepts will have no link or relationship between them, in an embodiment, the Relationship Matrix 260 is sparsely populated, meaning that the majority of the elements in the Relationship Matrix 260 are zero or null.

As illustrated, the Consistency Generator 245 analyzes the Relationship Matrix 260 to generate consistency scores or measures for one or more relationships. In one embodiment, a user or administrator indicates a relationship to be tested, and the Consistency Generator 245 generates a consistency score for that relationship, as discussed in more detail below. In embodiments, the relationship need not be one that was actually located in the literature, and can include a relationship between concepts which has not been identified or observed. In such an embodiment, users or administrators can select relationships to be tested, in order to determine if they are consistent with the existing literature.

In some embodiments, the Consistency Generator 245 can identify one or more relationships to be tested, without input from a user. For example, in one embodiment, the Consistency Generator 245 identifies relationships that were infrequently found in the literature (e.g., a number of occurrences below a predefined threshold), and selects one or more of these questionable relationships for verification. This may be particularly useful if the relationships have not been verified by a user (e.g., no user has confirmed that the identified relationship is actually specified or indicated in the document, and it may be the result of a faulty or inaccurate ingestion algorithm). In a related embodiment, the Consistency Generator 245 can analyze each newly identified relationship. For example, in one embodiment, each time a relationship is found or stated for the first time, the Consistency Generator 245 analyzes this relationship to determine its consistency with respect to the domain.

In one embodiment, to determine the consistency of a relationship, the Consistency Generator 245 sets the value of the corresponding element in the Relationship Matrix 260 to zero, and factorizes the Relationship Matrix 260 to generate matrices that, when multiplied, approximate the original Relationship Matrix 260. In one embodiment, the Consistency Generator 245 utilizes Alternating Least Squares (ALS) matrix factorization. For example, suppose the Relationship Matrix 260 is a matrix X with M row and N columns, where the value of the element at row m and column n is non-zero if and only if the relationship from m to n has been identified in the literature. Suppose further that the matrix X is factored into matrices H and W. In an embodiment, the Consistency Generator 245 can then multiply H and W to generate a new matrix X′. In such an embodiment, the value of X′ [a, b] (e.g., the value of the element of X′ at row a and column b) represents the relative consistency score for the relationship a→b.

In some embodiments, to provide additional context, the Consistency Generator 245 identifies one or more related or relevant relationships to the relationship being tested, and repeats this process to generate corresponding consistency scores. The index relationship (e.g., the relationship being tested) can then be compared to other relevant relationships, to determine how consistent the relationship is in the domain. In one embodiment, the relevant relationships are those that share the same starting point as the index relationship. For example, in such an embodiment, for a relationship a→b, the relevant relationships are all relationships that also begin at the concept a (e.g., all relationships a→N). In some embodiments, the relevant relationships are those that end at the same target concept, regardless of their start points. For example, in such an embodiment, for a relationship a→b, the relevant relationships are all relationships that also end at the concept b (e.g., all relationships M→b). In some embodiments, the relevant relationships are those that share at least one endpoint of the index relationship.

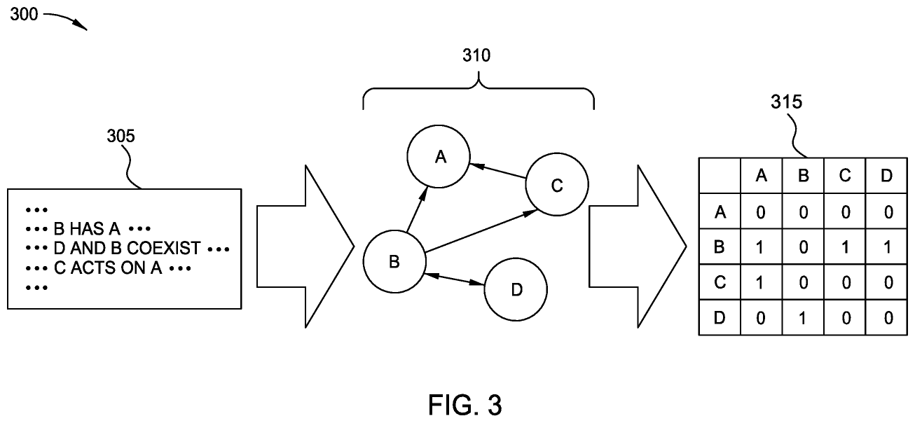

FIG. 3 illustrates a workflow 300 for generation of a Knowledge Graph 310 and Matrix 315 for determining relative consistency of relationships, according to one embodiment disclosed herein. In the illustrated workflow 300, one or more documents in the literature are parsed at block 305 to identify relationships between concepts. As discussed above, in embodiments, the Relationship Identifier 235 uses an Ontology 250 to identify concepts and relationships. As illustrated, based on these relationships, the Relationship Identifier 235 generates a Knowledge Graph 310, where each node represents an identified concept, and each link or connection indicates an identified relationship. In the illustrated embodiment, each connection is directional (e.g., it begins at an agent and terminates at a target). Although only four nodes are illustrated, in embodiments, the Knowledge Graph 310 may be any size.

In some embodiments, the type of the identified connection or relationship can further define its directionality. For example, in the illustrated embodiment, the connection between nodes B and C is bidirectional. This may be because, for example, the literature indicated that the concepts coexist, are co-located, are related, and the like, without specifying a particular direction of the relationship. Similarly, in some embodiments, if directional relationships are separately identified in each direction (e.g., from B to D and from D to B), the Relationship Identifier 235 can consolidate them into a single bidirectional connection. Further, in some embodiments, the connections are directionless.

As illustrated in the workflow 300, the Matrix Generator 240 parses this Knowledge Graph 310 to generate a Matrix 315. In the illustrated embodiment, each row in the Matrix 315 represents a unique agent from the Knowledge Graph 310 (e.g., each node that acts as the agent for at least one relationship is included in its own row in the Matrix 315). Similarly, each column represents a unique target of one or more relationships. Further, as illustrated, the value of each element is set to either one or zero, depending on whether there is a corresponding link in the Knowledge Graph 310. As discussed above, in embodiments, the Consistency Generator 245 sets the value of the index relationship to zero, factorizes the Matrix 315, and multiples the resulting matrices together to determine a consistency score for the index relationship. For example, if the relationship B→C is being tested, the Consistency Generator 245 will set the corresponding element to zero prior to factorizing the Matrix 315.

In the illustrated embodiment, there is a row for the element “A,” despite the fact that “A” does not act as an agent for any identified relationships. As illustrated, each entry in the row is set to zero, to indicate that “A” is not an agent for any known relationships. In some embodiments, if a concept is not an agent for any known relationships, however, the Knowledge Graph 315 does not include a row for the concept. Further, as illustrated, the value of the field corresponding to the relationship from a concept to itself is zero. That is, the value for the relationship A→A is zero, as is the value for B→B, C→C, and D→D. In some embodiments, however, this reflexive relationship is given a value of one, or some other value.

As discussed above, in embodiments, relevant relationships are identified and tested in a similar manner. That is, in one embodiment, for each relevant relationship, the Consistency Generator 245 sets the corresponding value to zero, factorizes the Matrix 315, and multiples the resulting matrices to determine the consistency score for the relevant relationship. In some embodiments, the Consistency Generator 245 determines the consistency score for each relevant relationship based on the same matrix (e.g., based on the matrix generated by multiplying the factorized matrices together in order to determine the score of the index relationship). In this way, the Consistency Generator 245 generates a number of consistency scores, and the relative consistency of each relationship can be compared to better understand an overall consistency of the index relationship, as compared to other relevant relationships.

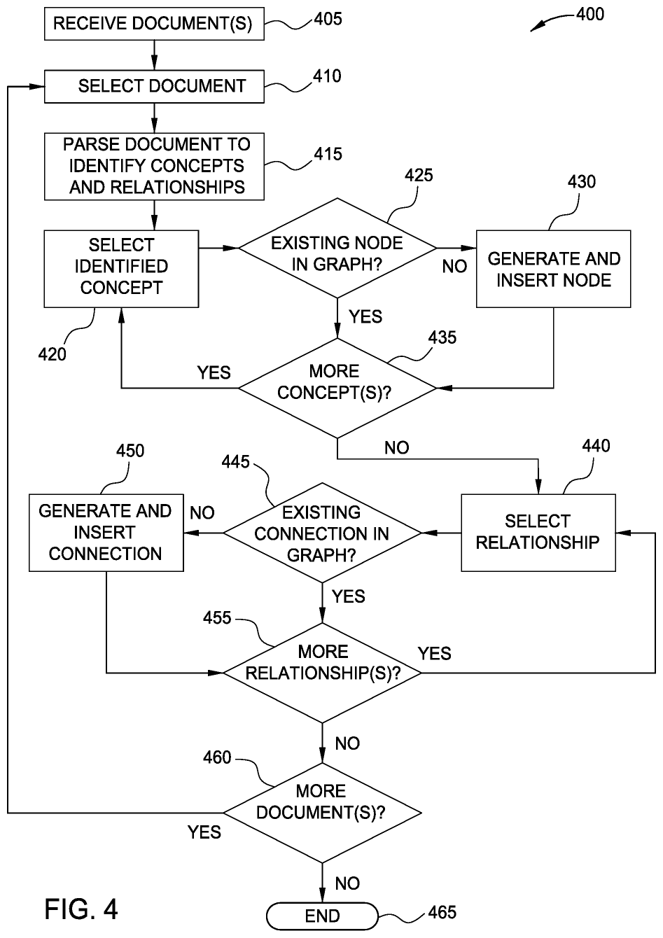

FIG. 4 is a flow diagram illustrating a method 400 of generating a knowledge graph to determine the relative consistency of identified relationships, according to one embodiment disclosed herein. The method 400 begins at block 405, where the Relationship Identifier 235 receives one or more documents to be parsed. In embodiments, these documents may be provided by a user or administrator, or the Relationship Identifier 235 may access documents stored in one or more data stores (e.g., over the Internet). The method 400 then proceeds to block 410, where the Relationship Identifier 235 selects a document for processing.

At block 415, the Relationship Identifier 235 parses the document (such as with one or more NLP techniques) to identify concepts and relationships in the selected document. In one embodiment, each concept can be either an entity (such as a gene, a therapy, a medication, and the like) or a property of an identified entity. In some embodiments, as discussed above, each relationship is directional. That is, in such an embodiment, a relationship a→b does not imply a relationship b→a necessarily exists. In one embodiment, the directionality of each relationship is determined based on which concept is the agent and which is the target. Further, in an embodiment, a concept is classified as the agent or target based on whether it is the subject or object of the sentence, respectively.

The method 400 then proceeds to block 420, where the Relationship Identifier 235 selects one of the identified concepts from the document. At block 425, the Relationship Identifier 235 determines whether the selected concept is already represented by a node in the graph. For example, in one embodiment, the Relationship Identifier 235 determines whether there is a node in the graph that indicates or specifies the concept. Similarly, in some embodiments, the Relationship Identifier 235 utilizes one or more ontologies to determine whether a node in the graph indicates or specifies an equivalent concept (e.g., a different name or phrase for the same concept). If there is no such node, the method 400 proceeds to block 430, where the Relationship Identifier 235 generates and inserts a node for the selected concept. The method then continues to block 435. Alternatively, if such a node already exists in the graph, the method 400 continues to block 435.

At block 435, the Relationship Identifier 235 determines whether there is at least one additional concept identified in the selected document which has not yet been parsed. If so, the method 400 returns to block 420 to select the next concept. If not, the method 400 proceeds to block 440, where the Relationship Identifier 235 selects a first of the identified relationships. At block 445, the Relationship Identifier 235 determines whether there is an existing connection in the graph to represent the selected relationship. That is, the Relationship Identifier 235 identifies the agent and target of the relationship, and determines whether the graph already includes a link from the agent to the target (e.g., it has already been identified and inserted). If so, the method 400 continues to block 455. In some embodiments, the Relationship Identifier 235 increments the weight of the existing connection, in order to indicate higher confidence in the relationship. If there is not an existing connection for the selected relationship, the method 400 continues to block 450, where the Relationship Identifier 235 generates and inserts such a connection. The method 400 then proceeds to block 455.

At block 455, the Relationship Identifier 235 determines whether there is at least one additional relationship identified in the selected document which has not yet been processed. If so, the method 400 returns to block 440. If not, the method 400 continues to block 460. At block 460, the Relationship Identifier 235 determines whether there are any additional documents yet to be processed and ingested. If there is at least one such document, the method 400 returns to block 410. Otherwise, the method 400 terminates at block 465. In this way, the Relationship Identifier 235 ingests literature to generate a knowledge graph. Further, as discussed above, in some embodiments, one or more of the relationships are verified or validated by a user in order to ensure that they accurately reflect the ingested literature (without regard to whether they accurately reflect the truth of the underlying claim).

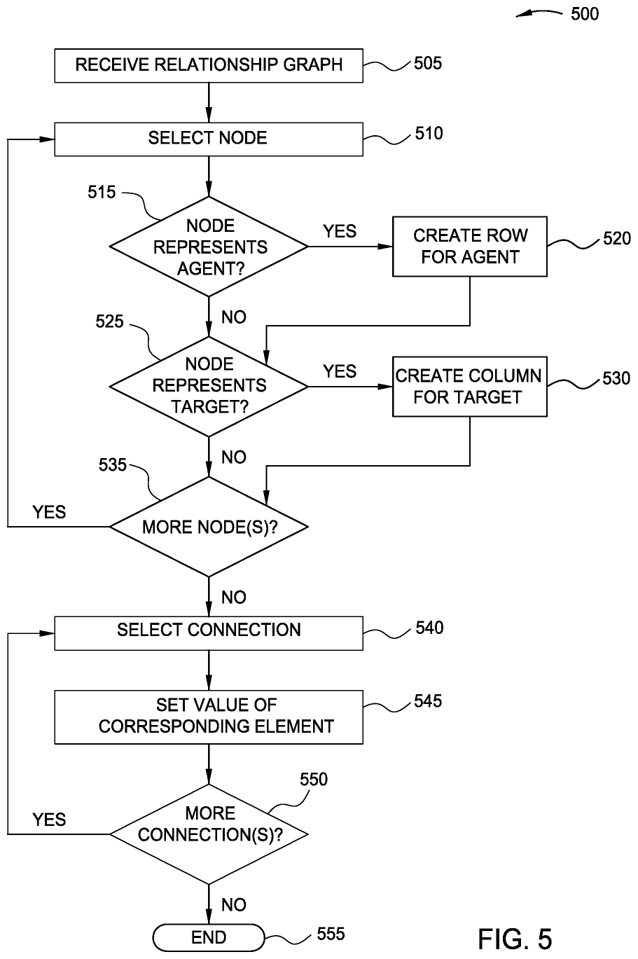

FIG. 5 is a flow diagram illustrating a method 500 of generating a matrix to be used in analyzing relationships between concepts in order to determine the relative consistency of each relation, according to one embodiment disclosed herein. In embodiments, if a relationship's consistency score is below a predefined threshold, the Consistency Analysis Application 230 can determine that the relationship itself is suspect and requires further investigation (e.g., with new studies), or that the ingestion technique (e.g., the NLP models used) are inaccurate or made a mistake. The method 500 begins at block 505, where the Matrix Generator 240 receives a relationship graph. In embodiments, this graph can be retrieved or received from any source, or may be generated by the Consistency Analysis Application 230 (e.g., by the Relationship Identifier 235). At block 510, the Matrix Generator 240 selects a first node in the graph. The method 500 then continues to block 515, where the Matrix Generator 240 determines whether the node represents an agent. That is, in an embodiment, the Matrix Generator 240 determines whether the selected node is the origin for at least one relationship.

If so, the method 500 continues to block 520, where the Matrix Generator 240 generates a row in the matrix for the agent. The method 500 then continues to block 525. Additionally, if, at block 515, the Matrix Generator 240 determines that the node is not an agent (e.g., there are no relationships or links that begin at the selected node), the method 500 continues to block 525. At block 525, the Matrix Generator 240 determines whether the node represents a target concept. For example, in an embodiment, the Matrix Generator 240 determines whether there is at least one link or connection that begins at a different node and ends or targets the selected node. If so, the method 500 continues to block 530, where the Matrix Generator 240 creates a column in the matrix for the selected concept. The method 500 then proceeds to block 535. Additionally, if, at block 525, the Matrix Generator 240 determines that the node does not represent a target, the method 500 proceeds to block 535. Note that in embodiments, a node may act as both a target and an agent, in different relationships.

At block 535, the Matrix Generator 240 determines whether the knowledge graph includes at least one more node that has yet to be processed. If so, the method 500 returns to block 510 to select the next node. Otherwise, the method 500 continues to block 540, where the Matrix Generator 240 selects a first connection in the graph. At block 545, the Matrix Generator 240 identifies the corresponding element in the matrix, and sets that element to a predefined value. For example, as discussed above, in one embodiment, the element is set to 1 if the connection exists. In some embodiments, the value can be set to higher values to indicate higher confidence in the relationship. For example, in one embodiment, the value is set based in part on the weight of the selected connection. In an embodiment, the elements in the matrix are initialized with a value of 0. In this way, after processing, the value of each element is non-zero if and only if the corresponding relationship has been identified at least once in the literature.

The method 500 then continues to block 550, where the Matrix Generator 240 determines whether there is at least one additional connection in the graph to be processed. If so, they method 500 returns to block 540. If not, the method 500 terminates at block 555. In this way, the Matrix Generator 240 constructs a matrix to represent the relationships that have been identified in the domain. Although the illustrated embodiment utilizes rows in the matrix to represent agents and columns to represent targets, in embodiments, the columns may represent agents while the rows represent targets. Further, in some embodiments, the matrix is generated without concern for the directionality of the relationships, and each concept has both a row and a column, regardless of whether it is an agent or a target for each relationship.

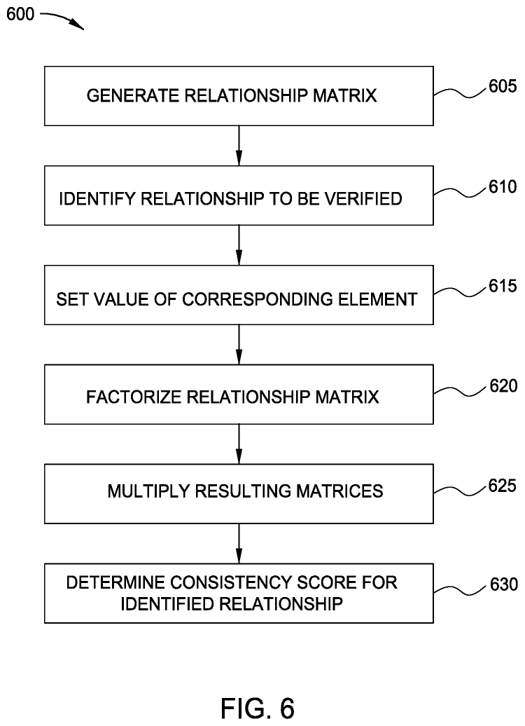

FIG. 6 is a flow diagram illustrating a method 600 of determining the relative consistency of relationships, according to one embodiment disclosed herein. The method 600 begins at block 605, where the Consistency Generator 245 generates the relationship matrix, as discussed above. At block 610, the Consistency Generator 245 identifies the relationship to be verified (i.e., the index relationship). As discussed above, in some embodiments, this index relationship is identified and provided by a user or administrator who wishes to test the consistency of the relationship. In some embodiments, the Consistency Generator 245 can identify these relationships automatically. For example, in one embodiment, the Consistency Generator 245 identifies relationships with a confidence value or weight below a defined threshold. Similarly, in one embodiment, the Consistency Generator 245 identifies relationships that have been newly discovered or announced (e.g., that were identified for the first time in a document that was released within a predefined period of time).

At block 615, the Consistency Generator 245 identifies the element in the relationship matrix that corresponds to the index relationship, and sets the value of the element to a predefined value. As discussed above, in some embodiments, the Consistency Generator 245 sets the value to zero in order to test the consistency of the index relationship. The method 600 then proceeds to block 620, where the Consistency Generator 245 performs matrix decomposition or factorization on the relationship matrix to generate two or more matrices. As discussed above, in embodiments, matrix factorization approximates a relatively sparse relationship matrix as two relatively more dense matrices.

At block 625, the Consistency Generator 245 multiplies the resulting matrices together. As discussed above, in embodiments, these matrices, when multiplied together, approximate the original matrix. In an embodiment, multiplying the generated matrices together yields a consistency value for each element in the matrix. In some embodiments, rather than multiply the entire matrices, the Consistency Generator 245 processes only the portions of the individual matrices that are needed to determine the value for the index relationship. Thus, at block 630, the Consistency Generator 245 determines the consistency score for the identified index relationship. In an embodiment, the consistency score is the value of the corresponding element in the multiplied matrix.

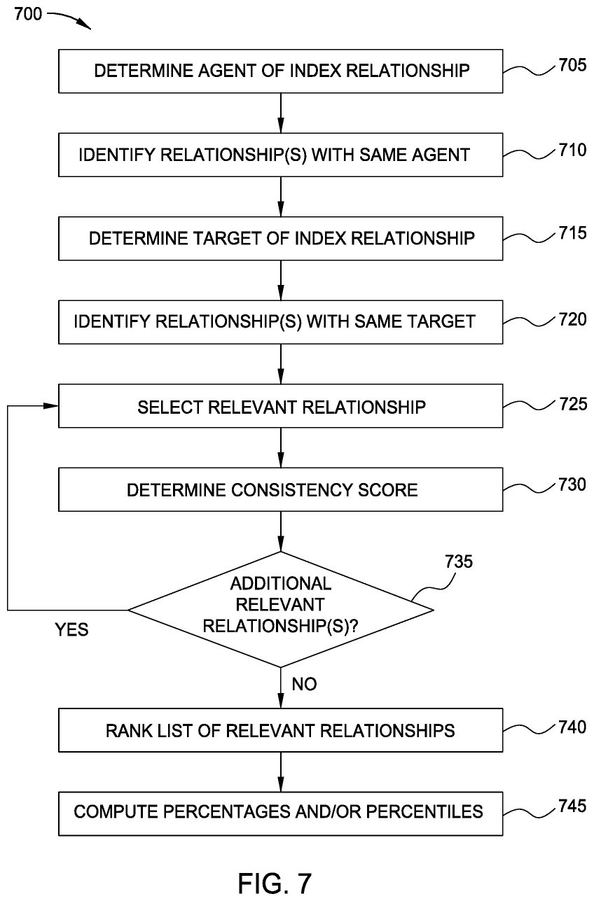

FIG. 7 is a flow diagram illustrating a method 700 for scoring the relative consistency of a relationship based on relevant or related relationships, according to one embodiment disclosed herein. The method 700 begins at block 705, where the Consistency Generator 245 determines the agent of the index relationship. At block 710, the Consistency Generator 245 identifies any other relationships with the same agent. For example, in one embodiment, the Consistency Generator 245 parses the original relationship matrix to identify the row corresponding to the index relationship's agent. In such an embodiment, the Consistency Generator 245 then analyzes each element in the identified row to determine if a relationship exists (e.g., if the value is non-zero). Similarly, in one embodiment, the Consistency Generator 245 accesses the relationship graph, and locates all connections or links that begin at the node associated with the agent of the index relationship.

The method 700 then proceeds to block 715, where the Consistency Generator 245 determines the target concept of the index relationship. At block 720, the Consistency Generator 245 identifies any other relationships with the same target. For example, in one embodiment, the Consistency Generator 245 parses the original relationship matrix to identify the column corresponding to the index relationship's target. In such an embodiment, the Consistency Generator 245 then analyzes each element in the identified column to determine if a relationship exists (e.g., if the value is non-zero). Similarly, in one embodiment, the Consistency Generator 245 accesses the relationship graph, and locates all connections or links that end at the node associated with the target of the index relationship.

Once these relevant or related relationships have been identified, the method 700 continues to block 725, where the Consistency Generator 245 selects a first of the identified relevant relationships. At block 730, the Consistency Generator 245 determines the consistency score of this selected relevant relationship. In one embodiment, the Consistency Generator 245 determines the value of the corresponding row in the final matrix that was generated by multiplying the factor matrices together. In some embodiments, the Consistency Generator 245 instead completes the process again for the selected relevant relationship. That is, in some embodiments, the Consistency Generator 245 accesses the original relationship matrix, sets the value of the selected relevant relationship to zero, factorizes the matrix, and multiples at least a portion of the matrices to determine the value for the element corresponding to the selected relevant relationship.

Once the consistency score for the selected relevant relationship is identified, the method 700 continues to block 735, where the Consistency Generator 245 determines whether there is at least one additional relevant relationship to be processed. If so, the method 700 returns to block 725. If not, the method 700 continues to block 740, where the Consistency Generator 245 ranks the relevant relationships (and the index relationship) based on their respective consistency scores. Finally, at block 745, the Consistency Generator 245 computes the percentages and/or percentiles for each relationship in the list. For example, in one embodiment, the Consistency Generator 245 determines the position of each relationship in the ranked list, and computes the number or percentage of relevant relationships that are ranked below the respective relationship. In this way, the Consistency Generator 245 allows users to readily understand how consistent each respective relationship is, with respect to the other relevant relationships in the list.

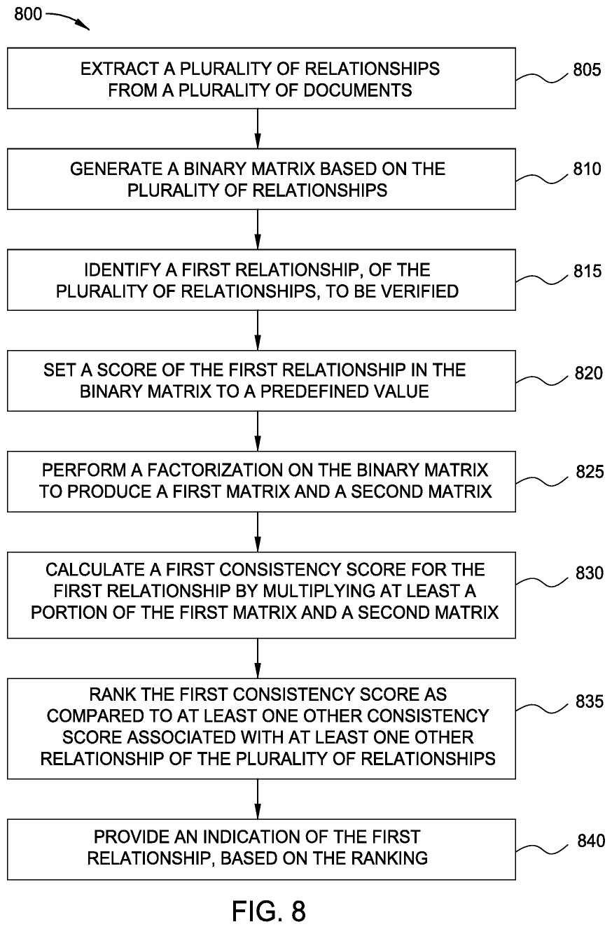

FIG. 8 is a flow diagram illustrating a method 800 of analyzing the relative consistency of relationships between concepts, according to one embodiment disclosed herein. The method 800 begins at block 805, where the Consistency Analysis Application 230 extracts a plurality of relationships from a plurality of documents by operation of one or more computer processors. At block 810, the Consistency Analysis Application 230 generates a binary matrix based on the plurality of relationships. The method 800 then continues to block 815, where the Consistency Analysis Application 230 identifies a first relationship, of the plurality of relationships, to be verified. Additionally, at block 820, the Consistency Analysis Application 230 sets a score of the first relationship in the binary matrix to a predefined value. The method 800 then proceeds to block 825, where the Consistency Analysis Application 230 performs a factorization on the binary matrix to produce a first matrix and a second matrix. At block 830, the Consistency Analysis Application 230 calculates a first consistency score for the first relationship by multiplying at least a portion of the first matrix and a second matrix. At block 835, the Consistency Analysis Application 230 ranks the first consistency score as compared to at least one other consistency score associated with at least one other relationship of the plurality of relationships. Finally, the method 800 terminates at block 840, where the Consistency Analysis Application 230 provides an indication of the first relationship, based on the ranking.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., the Consistency Analysis Application 230) or related data available in the cloud. For example, the Consistency Analysis Application 230 could execute on a computing system in the cloud and compute consistency scores for identified relationships. In such a case, the Consistency Analysis Application 230 could generate and process relationship matrices and store relationships and consistency scores at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
extracting a plurality of relationships from a plurality of documents by operation of one or more computer processors;
generating a binary matrix based on the plurality of relationships;
identifying a first relationship, of the plurality of relationships, to be verified;
setting a score of the first relationship in the binary matrix to a predefined value;
performing a factorization on the binary matrix to produce a first matrix and a second matrix;
calculating a first consistency score for the first relationship by multiplying at least a portion of the first matrix and a second matrix;
ranking the first consistency score as compared to at least one other consistency score associated with at least one other relationship of the plurality of relationships; and
providing an indication of the first relationship, based on the ranking.

2. The method of claim 1, wherein each of the plurality of relationships identifies a connection between two endpoints, wherein each of the endpoints is either: (i) an entity, or (ii) a property.

3. The method of claim 2, wherein ranking the first consistency score comprises:
identifying one or more relevant relationships, in the plurality of relationships, with respect to the first relationship; and
determining a respective consistency score for each respective relevant relationship.

4. The method of claim 3, and wherein the first relationship includes first and second endpoints, and wherein each of the one or more relevant relationships includes at least one of the first or second endpoints.

5. The method of claim 1, wherein extracting the plurality of relationships from the plurality of documents comprises parsing the plurality of documents using one or more natural language processing (NLP) techniques and a domain-specific ontology.

6. The method of claim 1, the method further comprising:
generating a graph of connected nodes, based on the plurality of relationships, wherein each node in the graph corresponds to either an agent or a target specified in at least one of the plurality of relationships, and wherein each connection in the graph corresponds to one of the plurality of relationships.

7. The method of claim 6, wherein each respective connection in the graph is associated with a direction from a respective agent to a respective target.

8. The method of claim 7, wherein generating the binary matrix comprises:
creating a row in the binary matrix for each unique agent identified in the plurality of relationships;
creating a column in the binary matrix for each unique target identified in the plurality of relationships; and
determining, for each respective element in the binary matrix, whether the graph includes a corresponding connection, wherein a value of the respective element is set to one if the graph includes the corresponding connection, and wherein the value of the respective element is set to zero if the graph does not include the corresponding connection.

9. The method of claim 1, wherein calculating the first consistency score for the first relationship comprises:
generating a third matrix by multiplying the first matrix and a second matrix; and
determining a value of an element, in the third matrix, corresponding to the first relationship.

10. A computer program product comprising:
a computer-readable storage medium having computer-readable program code embodied therewith, the computer-readable program code executable by one or more computer processors to perform an operation comprising:
extracting a plurality of relationships from a plurality of documents;
generating a binary matrix based on the plurality of relationships;
identifying a first relationship, of the plurality of relationships, to be verified;
setting a score of the first relationship in the binary matrix to a predefined value;
performing a factorization on the binary matrix to produce a first matrix and a second matrix;
calculating a first consistency score for the first relationship by multiplying at least a portion of the first matrix and a second matrix;
ranking the first consistency score as compared to at least one other consistency score associated with at least one other relationship of the plurality of relationships; and
providing an indication of the first relationship, based on the ranking.

11. The computer program product of claim 10, wherein ranking the first consistency score comprises:
identifying one or more relevant relationships, in the plurality of relationships, with respect to the first relationship; and
determining a respective consistency score for each respective relevant relationship.

12. The computer program product of claim 10, the operation further comprising:
generating a graph of connected nodes, based on the plurality of relationships, wherein each node in the graph corresponds to either an agent or a target specified in at least one of the plurality of relationships, and wherein each connection in the graph corresponds to one of the plurality of relationships.

13. The computer program product of claim 12, wherein each respective connection in the graph is associated with a direction from a respective agent to a respective target.

14. The computer program product of claim 13, wherein generating the binary matrix comprises:
creating a row in the binary matrix for each unique agent identified in the plurality of relationships;
creating a column in the binary matrix for each unique target identified in the plurality of relationships; and
determining, for each respective element in the binary matrix, whether the graph includes a corresponding connection, wherein a value of the respective element is set to one if the graph includes the corresponding connection, and wherein the value of the respective element is set to zero if the graph does not include the corresponding connection.

15. The computer program product of claim 10, wherein calculating the first consistency score for the first relationship comprises:
generating a third matrix by multiplying the first matrix and a second matrix; and
determining a value of an element, in the third matrix, corresponding to the first relationship.

16. A system comprising:
one or more computer processors; and
a memory containing a program which when executed by the one or more computer processors performs an operation, the operation comprising:
extracting a plurality of relationships from a plurality of documents;
generating a binary matrix based on the plurality of relationships;
identifying a first relationship, of the plurality of relationships, to be verified;
setting a score of the first relationship in the binary matrix to a predefined value;
performing a factorization on the binary matrix to produce a first matrix and a second matrix;
calculating a first consistency score for the first relationship by multiplying at least a portion of the first matrix and a second matrix;
ranking the first consistency score as compared to at least one other consistency score associated with at least one other relationship of the plurality of relationships; and
providing an indication of the first relationship, based on the ranking.

17. The system of claim 16, wherein ranking the first consistency score comprises:
identifying one or more relevant relationships, in the plurality of relationships, with respect to the first relationship; and
determining a respective consistency score for each respective relevant relationship.

18. The system of claim 16, the operation further comprising:
generating a graph of connected nodes, based on the plurality of relationships, wherein each node in the graph corresponds to either an agent or a target specified in at least one of the plurality of relationships, and wherein each connection in the graph corresponds to one of the plurality of relationships.

19. The system of claim 18, wherein each respective connection in the graph is associated with a direction from a respective agent to a respective target.

20. The system of claim 19, wherein generating the binary matrix comprises:
creating a row in the binary matrix for each unique agent identified in the plurality of relationships;
creating a column in the binary matrix for each unique target identified in the plurality of relationships; and
determining, for each respective element in the binary matrix, whether the graph includes a corresponding connection, wherein a value of the respective element is set to one if the graph includes the corresponding connection, and wherein the value of the respective element is set to zero if the graph does not include the corresponding connection.
